(19) United States
(12) Patent Application Publication
(10) Pub. No.: US 2013/0159189 A1
(43) Pub. Date: Jun. 20, 2013

(54) TRUST MANAGEMENT SYSTEM

(71) Applicant: Eric Solis, Corona del Mar, CA (US)

(72) Inventor: Eric Solis, Corona del Mar, CA (US)

(73) Assignee: JH Portfolio Debt Equities LLC, Woodland Hills, CA (US)

(21) Appl. No.: 13/723,071

(22) Filed: Dec. 20, 2012

Related U.S. Application Data
(60) Provisional application No. 61/578,038, filed on Dec. 20, 2011.

(51) Int. Cl. G06Q 50/16; G06Q 40/00

(52) U.S. Cl. CPC G06Q 50/16; G06Q 40/00
USPC 705/44

(57) ABSTRACT

An automated method and system for managing Native American land trust rights is described. Login information may be received from a participant. An account record associated with the participant may be accessed to identify one or more land trust rights held by the participant. An offer to purchase at least one land trust right of the one or more land trust rights held by the participant may be made. An input from the participant accepting or rejecting the offer to purchase may be received. Upon acceptance of the offer, payment may be disbursed to the participant in accordance with the offer to purchase and account record associated with the participant may be updated to reflect a sale of the at least one land trust right.

### RELATED APPLICATION INFORMATION

This patent claims priority from the following provisional patent applications: Provisional Patent Application No. 61/578,038, entitled Incremental Money Transfer, filed Dec. 20, 2011, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to automation of financial transactions, including automatic management of Native American trust accounts.

2. Description of the Related Art

During the late 1800s, Congress and the Executive branch believed that the best way to foster assimilation of Native Americans was to “introduce among the Indians the customs and pursuits of civilized life and gradually absorb them into the mass of our citizens.” Under the General Allotment Act of 1887 (the Dawes Act), tribal lands were divided and assigned to heads of households as individually owned parcels 40-160 acres in size. The Dawes Rolls are the records of the beneficiaries of each tribe who were registered at the time.

The Dawes Act was named for its author, Senator Henry Dawes of Massachusetts. Also known as the General Allotment Act, the law allowed for the President to break up reservation land, which was held in common by the beneficiaries of a tribe, into small allotments to be parceled out to individuals. Thus, Native Americans who registered on a tribal “roll” were granted allotments of reservation land. “To each head of a family, one-quarter of a section; To each single person over eighteen years of age, one-eighth of a section; To each orphan child under eighteen years of age, one-eighth of a section; and To each other single person under eighteen years now living, or who may be born prior to the date of the order of the President directing an allotment of the lands embraced in any reservation, one-sixteenth of a section.”

The allotment regime created by the Dawes Act was never intended to be a permanent solution; it was supposed to transition gradually into fee simple ownership over a period of 25 years, about one generation. However, the theory that Indians could be turned into farmers, working their allotted lands was folly, not the least because much of the land they were allotted was unsuitable for family farms. By passage of a series of statutes in the early 1900s, the government's trusteeship of these lands increasingly was made a permanent arrangement. Little thought was given at the time to the consequences of making permanent the bequeathing of allotments. Lands allotted to individual Native Americans were passed from generation to generation, just as any other family asset passes to heirs. Probate proceedings commonly stipulated that land interests must be divided equally among every eligible heir unless otherwise stated in a will. However, wills were not, and are not, commonly used by Native Americans. Thus, as original allottees die, their heirs receive equal, undivided interests in the allottees' lands. In successive generations, smaller undivided interests descend to the next generation. Fractionated interests in individual Indian allotted land continue to expand geometrically with each new generation.

Today, there are approximately four million owner interests in the 10,000,000 acres of individually owned trust lands, which makes management of trust assets extremely difficult and costly. For example, track 1305 was described in 1987 in Hodel v. Irving, 481 U.S. 704 (1987). Tract 1305 is 40 acres and, in 1987, produced $1,080 in income annually. It was valued at $8,000. At the time, Tract 1305 had 439 owners, one-third of whom received less than $.05 in annual income and two-thirds of whom received less than $1. The largest interest holder received $82.85 annually. The administrative cost to manage this tract in 1987 was estimated by the Bureau of Indian Affairs to be $17,560 annually, or $40 per interest holder. This cost is clearly disproportionate to the value of the tract and the income it produces. Further, highly fractionated ownership greatly reduces the value of land tracts since such tracts are essentially unsellable.

Cobell v. Salazar, a class action law suit filed in the United States District Court of Columbia, clearly defines the scope and scale of the numerous problems associated with the management of the original allotted Native American Trust lands. On December 21, 2010, The United States District Court for the District of Columbia granted preliminary approval of a Settlement. Legislation approving the Settlement and authorizing $3.4 billion in funds to be paid in damages to tribes and their beneficiaries was signed into law on Dec. 8, 2010.

However, the Settlement does not solve the problem. It does quantify and resolve the financial differences between the US Government and the Native Americans who have inherited land from the original allotment process. Going forward, a system is required to accurately maintain records of ownership and offer account access and communication to tribal members while containing the costs associated with the management and administration of these trust accounts.

### DESCRIPTION OF THE DRAWINGS

FIG. 1 is a block diagram of an incremental money transfer system.

FIG. 2 is a block diagram of a regulatory transaction chain.

FIG. 3 is a block diagram of a trust management system.

FIG. 4 is a flow chart of a process for managing rights.

FIG. 5 is a flow chart of a process for consolidating rights.

### DETAILED DESCRIPTION

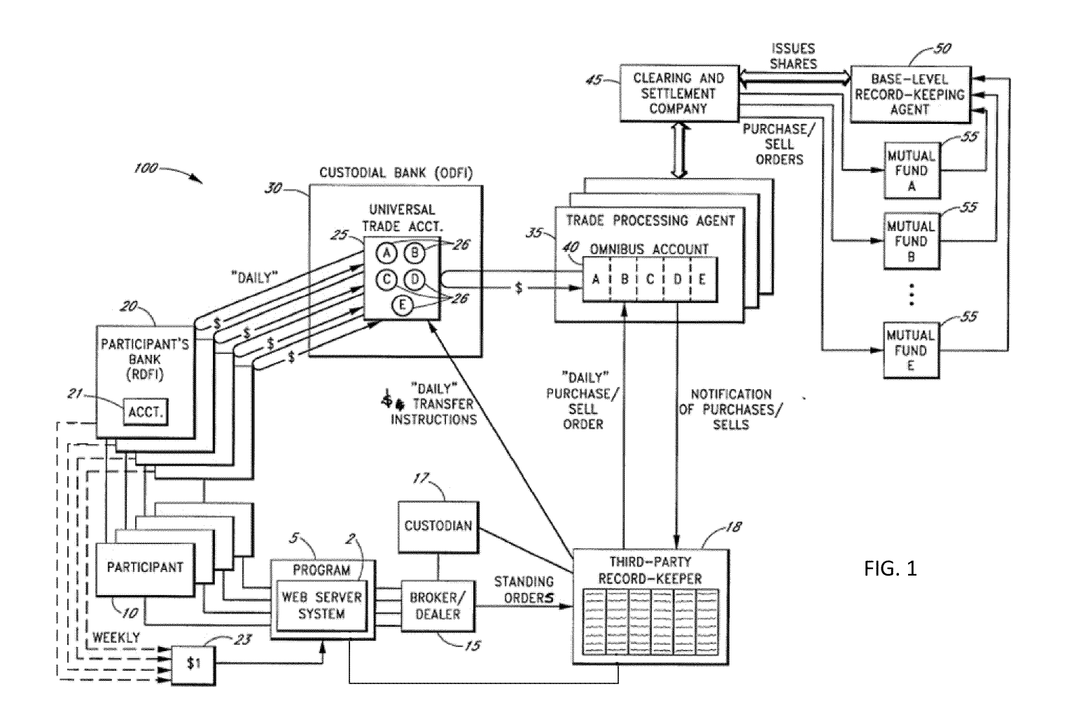

FIG. 1 is a block diagram depicting an incremental money transfer system 100 that allows participants 10 to enroll in a program 5 in order to contribute to one or more financial products 55 automatically, incrementally, and at a pre-determined frequency. The innovative program 5 allows participants 10, who may have only very limited amounts of money for investing in a retirement fund, or for otherwise contributing to a desired target account, to make contributions on a scale that fits within their budgets. The program 5 may further provide great flexibility to the participants 10, who may change their instructions the program 5 in various ways, such as instructing the program 5 to temporarily suspend their contributions, when desired, without penalty.

A participant 10 who wishes to participate in the system 100 contacts the program 5 in order to set up agreements that allow for the incremental, automatic money transfers to be executed in a manner that both fits the participant's budget and complies with all applicable government regulations. Participants 10 may communicate with the program 5 electronically. For example, the program 5 may include a web server system 2 that provides one or more websites, available via the Internet or other computer network, through which participants 10 may (a) register with the program 5, and, once registered, (b) make changes to the agreements that govern their contributions on a regular basis, and (c) track their contributions and other aspects of their participation in the program 5.

In brief, registering with the program 5 includes entering into a set of agreements that may specify, among other things, (a) the financial product or products 55 to which the participant 10 wishes to contribute, (b) a contribution amount that the participant 10 commits to contributing, (c) a bank account 21 owned by the participant from which the contributions will be drawn, and (d) a frequency at which contributions will be made. The contributions may be made and the investment shares purchased once per business day that financial markets are open for business, which is typically approximately 252 days per calendar year. A participant agreement summarizes conditions of the participant's 10 participation in the program 5

In the example of FIG. 1, the participant 10 may contribute to one or more of five mutual funds (A-E) 55 as part of an Individual Retirement Account (IRA). For example, participants 10 choose between five lifestyle funds offered through Fidelity-Advisor Freedom funds which are “dynamic asset allocation models” that are synchronized to the investor's retirement date, as will be described in greater detail below. Participants 10 may, additionally or alternatively, contribute to other types of financial products, including, but not limited to: other types of investments, insurance plans, health savings accounts, college savings, individual and joint accounts, mortgages, and the like.

As will be described in greater detail, contributions are automatically debited from a bank account 21 that the participant 10 designates and authorizes during the registration process. The participant 10 authorizes at least a minimum “daily” contribution of one dollar. Depending on the type of financial instrument 55 being offered by the program 5, government regulations or other legal constraints may dictate a maximum amount, such as an annual maximum amount, that a participant 10 may contribute to the financial products 55 in a given year. Participants 10 who wish to contribute the maximum amount may elect to contribute a fraction of the maximum, such that by making regular contributions over the course of a year, the maximum contribution amount will be reached. For example, contributions to an IRA may be limited by law to a maximum of $4,000 per year for individuals under fifty years of age. Assuming one contribution per business day of the calendar year, or a total of 252 contributions per year, a participant could elect to contribute $15.87 per business day in order to reach the maximum allowed contribution by the end of the year. Alternatively, the participant 10 may elect to contribute another amount.

As part of the registration process, the participant 10 enters into an agreement with a broker/dealer 15 who is authorized to purchase and sell securities and perform other regulated activities on behalf of the participant 10. The program 5 may perform many of the front-end tasks associated with engaging a new client for the broker-dealer 15, thereby greatly lessening the work on the part of the broker-dealer 15 to maintain the participant 10 as a client. As will be described with in greater detail, the program 5 also sets up the processes by which shares, or portions of shares, in the desired financial product 55 are purchased and settled on behalf of the participant 10, thereby further lessening the work undertaken by the broker/dealer 15 to maintain the participant 10 as a client.

When the participant 10 is using the program 5 to make the contributions to an IRA, a custodian 17 for the IRA is appointed to oversee correct administration of the IRA. Services provided by the custodian 17 may include all, some, or none of: custody of participant 10 investments through the program 5, delivery of periodic account statements, tax reporting relating to the investments, delivery of mutual fund prospectuses and proxy solicitation materials, when applicable, and similar services.

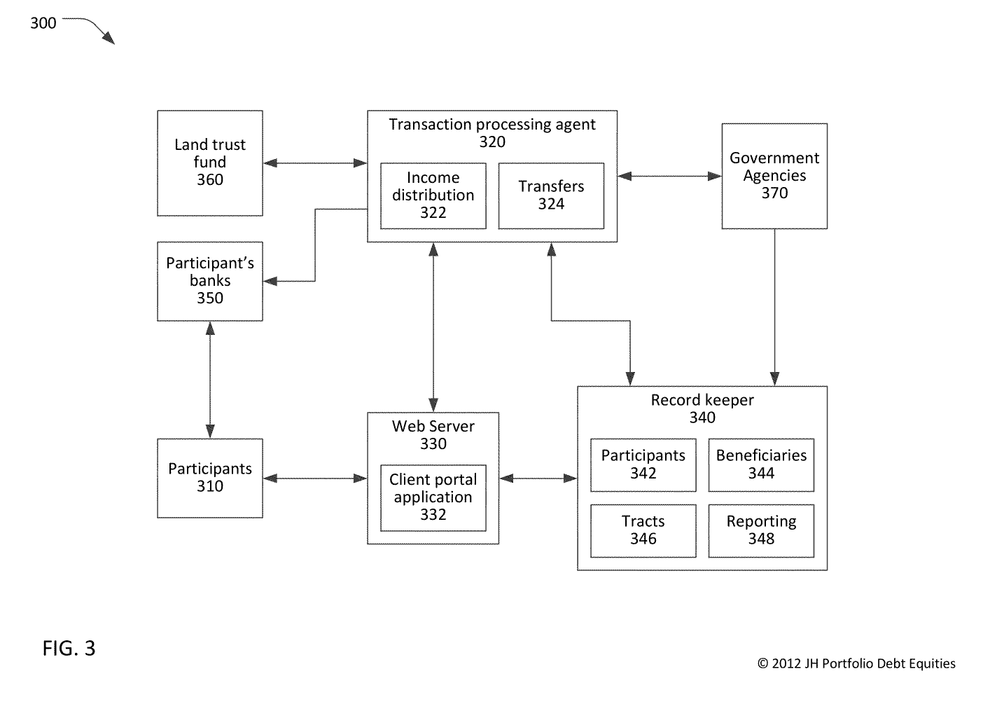

In addition, the program 5 appoints a third-party record-keeper 18 to track, at a very detailed level, information associated with activities occurring on behalf of the participant 10 in accordance with the program 5. The third-party record-keeper 18 stores electronic copies of agreements executed between the participant 10 and various entities of the system 100, including, but not limited to, the program 5 (a participant agreement), the broker-dealer 15, the custodian 17, and the banks. The third-party record-keeper 18 also keeps track of all monies debited from the participants' bank accounts 21 by the system 100, as well as all shares, or other changes associated with the financial products 55 that are executed in accordance with the participant agreement. FIG. 3 provides a simplified example of a record maintained by the third-party record-keeper 18 for a sample participant 10.

Because of the highly regulated nature of the banking and securities industries, the third-party record-keeper 18 may be an entity that stores data and executes instructions in a manner that complies with all relevant governmental and other constraints. Accordingly, the broker-dealer 15 and the custodian 17, who have various legal oversight obligations for securities being purchased on behalf of the participant 10, have electronic access to records maintained by the third-party record-keeper that relate to the participant's 10 registration with the program 5 and activities undertaken on behalf of the participant 10.

A universal trade account 25, established at a custodial bank 30 by the third-party record-keeper 18 in connection with the program 5, is used to hold funds for settlement, namely purchases and redemptions, of shares in the mutual funds 55 (or other financial products) on behalf of participants 10 of the program 5. The custodial bank 30 may be a bank such as United Missouri Bank (UMB). The universal trade account 25 may comprise sub-accounts 26 that correspond to individual mutual funds 55. The universal trade account 25 may be a demand deposit account that is established by the third-party record-keeper on behalf of the participants 10 of the program 5.

Periodically, such as each business day, and in accordance with program guidelines, the third-party record-keeper 18 transmits instructions to the custodial bank 30 on behalf of each participant 10 who is making a contribution that day. The instructions direct the custodial bank 30 to issue a “debit pull” operation to the respective participant bank accounts 21 for the respective contracted contribution amounts and, when received, to deposit the aggregated contributions into the universal trade account 25. The funds from each participant 10 may be associated with one or more of the sub-accounts 26 in accordance with the participants' instructions. The “debit pull” operations are carried out as defined by the Automated Clearing House (ACH).

Meanwhile, the third-party record keeper 18 also issues a “daily” purchase/sell order for shares, or portions of shares, in the financial products 55. The purchase/sell order specifies one or more purchase and/or sell transactions in accordance with the amounts of the contributions instructed by the participants 10 to be drawn from the participant accounts 21. The purchase/sell order is issued to a trade processing agent 35 that executes purchases and sales of the mutual funds 55 or other securities or financial products on behalf of the program 5. The trade processing agent 35 may be a brokerage arm of the mutual funds 55. The trade processing agent 35 need not be a brokerage arm of the mutual funds 55. The trade processing agent 35 may be the State Street Bank and Trust Company.

The trade processing agent 35 is typically affiliated with a clearing and settlement company 45 that serves as a conduit for interactions with the financial products 55. When the financial products 55 are mutual funds, the clearing and settlement company 45 may be the Depository Trust & Clearance Corporation (DTCC), which is a central counterparty that provides centralized clearance, settlement, and information services for broker-to-broker equity, corporate bond, municipal bond, exchange-traded funds, and unit investment trust (UIT) trades in the United States.

Alternatively, the clearing and settlement company 45 may be a non-profit consortium of financial institutions, such as the Defined Contribution Clearance & Settlement (DCC&S) that facilitates the automated processing and reporting of various defined contribution transactions and retirement plans.

The clearing and settlement company 45 acts together with a base-level record-keeping agent 50 to track and record purchases and settlements of shares of the mutual funds 55 on behalf of the trade processing agent 35.

When the trade processing agent 35, places an order for one or more shares, or one or more portion of shares, in the financial instrument 55, with the clearing and settlement company 45, the trade processing agent 35 typically has one day to produce the funds to the clearing and settlement company 45 to settle the order placed. Thus, if the date that the order is placed (the “trade date”) is designated as “T” then the funds for settling the order are due on “T+1.”

The trade processing agent 35 maintains an omnibus account 40 for managing settlement funds for purchase/sell orders executed on behalf of participants 10 of the program 5. The omnibus account 40 typically includes sub-accounts that correspond to the individual mutual funds 55 that are made available to the participants 10 through the program 5 and that are brokered by the trade processing agent 35.

The third-party record-keeper 18 may instruct the custodial bank 30 to wire monies from the universal trade account 25 to the omnibus account 40 for use in settling the purchase/sell orders. The trade processing agent 35 may cause an electronic communication to be transmitted to the custodial bank 30 so that the funds to be used for settlement of the purchase/sell orders are wired from the sub-accounts 26 of the universal trade account 25 to the omnibus account 40. In either case, the funds may be available in the omnibus account 40 in time to be used for settlement on day “T+1.”

The funds for settlement of the individual financial products 55 offered, such as for the individual mutual funds (A-E), may be transmitted by the custodial bank 30 by individual bank wires. Alternatively, one wire may be transmitted by the custodial bank 30 for sending an aggregated amount that includes contributions for all or some of the individual financial products 55, such as for all of the individual mutual funds (A-E). The wire may include an appended file defining the amount of monies to be applied towards each of the financial products 55. A practitioner skilled in the art will, upon review of this disclosure, recognize that other methods of transferring the funds from the custodial bank 30 to the omnibus account 40 may be used while remaining within the spirit and scope of this disclosure.

Once the day's one or more purchase/sell transactions have settled, the trade processing agent 35 sends a notification to the third-party record-keeper 18, and the third-party record-keeper 18 updates the associated participant records to reflect the new contributions.

The automated incremental money transfer program 5, including the process flows and functions described above, may be embodied in (and fully automated by) software code modules executed by one or more general purpose computers. The code modules may be stored in any type of computer storage device or devices (hard disk storage, solid state RAM, etc.). The data stored by the third-party record-keeper 18 shown in FIG. 1 may be implemented using any type of computer storage device or devices, and using any type or types of data repositories (relational databases, flat files, caches, etc.).

Once funds have been transferred from the custodial bank 30 to the trade processing agent 35 for the purchase of shares in the financial product 55, no funds may exit the system 100 or be paid to the participants 10 except by way of the custodial bank 30 when the securities are sold and the proceeds are returned to the participant's bank account 21. This arrangement is significant, at least in part, because of the operating procedures of the ACH, which is used for making the electronic money transfers of the system 100. According to the ACH regulations, monies transferred from an RDFI to an ODFI may be rescinded for any of a variety of reasons, which may include insufficient funds in the account, a closed account, a stop payment order, a fraudulent signature or authorization, or failure of the paying financial institution. Rescinded items are known to be major risk facing institutions that conduct demand deposit money transfers, such as the money transfer that the custodial bank 30 makes to the trade processing agent 35 daily. That risk is factored in to the per-transaction transfer fees charged by the ODFI for carrying out the numerous “debit pulls” (approximately 252 “debit pulls” per participant per year) that are part of the system 100. The risk is also factored into the “hold times” that financial institutions may frequently place on transferred funds, hoping that they will “clear” before the money is paid out. The “closed-loop” nature of the system 100 means that, in effect, the monies sent to the trade processing agent 35 are “collateralized” by the securities that have been purchased using the transferred funds. There may be no danger that the participant 10 or another party may take the funds as cash and leave the system 100 without notifying the custodial bank 30. In case a transfer is rescinded and the funds need to be refunded to the RDFI, the shares purchased with the rescinded funds could, if desired, be liquidated and returned to the banks 30, 20.

The custodial bank 30 may therefore perceive the requested transactions as being less risky. The custodial bank 30 may be therefore willing to negotiate greatly reduced per-transaction transfer fees for program participant 10 transactions and/or is willing to expedite transfer of the funds, thereby allowing the funds to arrive at the trade processing agent's omnibus account 40 in time to settle the newly issued purchases. Each of these unique results greatly enhances the value of the program 5 to the participants 10.

Participants 10 enrolling in the program 5 may agree that, in addition to the approximately five “daily” withdrawals a week that are used in full for investing in the target account, a separate automated and pre-authorized withdrawal 23 is paid to an account on behalf of the program 5. Thus, the payment represents a program membership fee. The weekly withdrawal amount may be one dollar. Thus, the annual fee for participation in the program is $52, paid in $1 increments. Different participants 10 may be charged different membership fees, for any of a variety of reasons. For example, a reduced weekly fee 23 may be applied for participants 10 who join the program 5 near its inception, in order to encourage growth of the program 5. As another example, participants 10 who join the program through an organization with which they are affiliated, such as a large employee group, or a credit union, or members of a religious organization, may have specially negotiated, possibly reduced, program fees 23. Additionally, low program fees may be available to certain segments of the population, such as low-income individuals, students, or other targeted groups.

The program 5, which provides the participants 10 with access to beneficial investment and money transfer capabilities of the system 100, need not itself have access to the participants' monies, accounts or securities involved in the system 100, other than the weekly program fee 23 debited directly from the participants' bank accounts 21 and credited to the program 5. This separation of the program 5 from the participants' monies, securities, and accounts may be advertised to potential participants in order to engender confidence in the program 5 on their parts, especially when participants 10 know that the entities that do have access to the participants' monies, securities, and accounts are well-known and highly reputable entities.

Furthermore, although the program 5 assists the participants 10 to set up and maintain agreements with regulated entities (including, for example, the broker/dealer 15, the custodian 17, the third-party record-keeper 18, and the custodial bank 30) in order to execute automated incremental money transfers and to purchase and sell securities on behalf of the participants 10, the program 5 may set up and maintain the agreements without itself being a regulated entity.

A condition of participation in the program 5 may be an agreement, on the part of the participant 10, that most or all of the communication between the program participants 10 and the program 5 takes place electronically, such as via email, text message, web site, voice recognition software, or the like. Furthermore, to the extent that it may be necessary or desirable, most or all of the communication between the program participants 10 and the broker/dealer 15, the third-party record-keeper 18, the custodial bank 30, and/or the trade processing agent 35 also takes place electronically. Still further, most or all of the communication between any of: the broker/dealer 15, the third-party record-keeper 18, the custodial bank 30, the trade processing agent 35, the clearing and settlement company 45, and/or the base-level record-keeping agent 50 also takes place electronically. This reliance on electronic communications greatly reduces paper-based and face-to-face communications and record-keeping and is associated with a substantial reduction in program costs as well as a substantial increase in communication speed. As one example of an effect of reliance on electronic communications, financial transactions associated with the program settle more quickly, thereby posing less risk to parties involved in settlement of purchase/sell orders. Less risk and less time that funds are in a “float” state may be used to negotiate for lower transaction fees, thus allowing the program 5 to be offered to participants 10 at a low cost that would not be practical using more conventional financial processes.

Once a participant 10 has enrolled in the program 5, the participant 10 may log in to a website operated by the web server system 2. The web server system 2 provides a link in the website that allows the logged-in participant 10 to access information about his or her account and his or her participation in the program 5 directly from the third-party record-keeper 18.

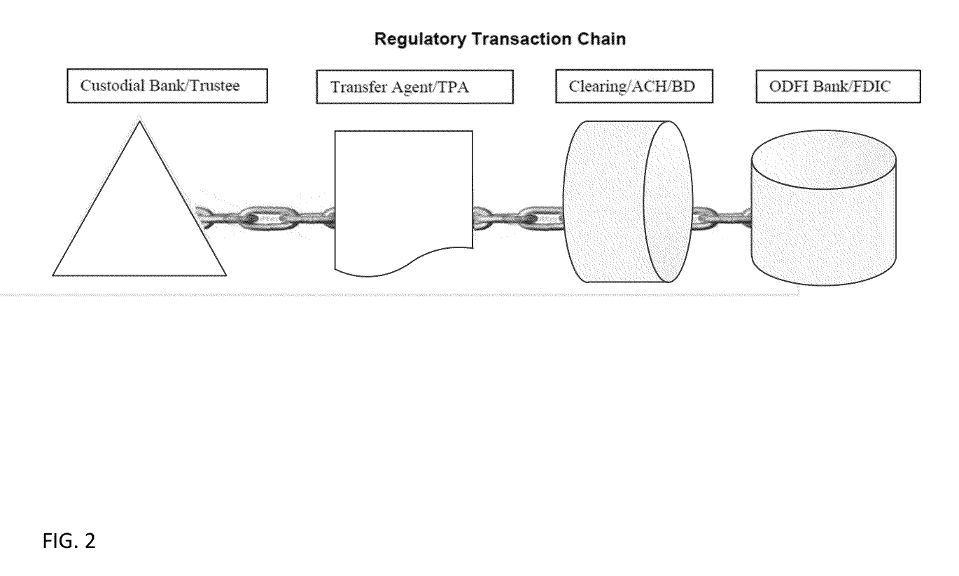

The system 100 utilizes a “regulatory transaction chain” as shown in FIG. 2. By linking the system together and inserting licensed and/or authorized entities to operate in accordance with the rules and regulations as stipulated by the various governing bodies, the system is able to ensure complete compliance at each link in the chain. These regulated services are provided by entities which are authorized to carry out functions which are authorized by governing bodies such as FDIC, SIPC, FINRA, the SEC and others. These entities may include Transfer Agents, Third Party Accounting, ODFI and RDFI Banks, Trustees, Broker Dealers, Registered Investment Advisors, Mutual Funds and Clearing firms.

FIG. 3 is a block diagram of a system 300 for managing Native American land trusts. The elements of the system 300 are generally similar to the counterpart elements of the system 100 except that the system 300 manages land trusts held by agencies of the U.S. Government 370, rather than investments in mutual funds.

Each participant in the system 300 may own rights to one or more tracts within one or more Native American land trusts. The participants 310 in the system 300 do not own land tracts as real property, since the land tracts are owned by the U.S. Government in trust for the participants. Rather, each participant in the system 300 may own rights to one or more tracts within one or more Native American land trusts.

Each participant 310 may interact with the system 300 via a web server 330 running a client portal application 332. The client portal application 332 may allow each participant to view the status of their account and their rights holdings, to initiate and complete transactions including sale and purchase of land trust rights, and to perform account maintenance tasks such as updating addresses.

The web server 330 may be coupled to a record keeper 340 that maintains a database 342 of participant data including the rights held by each participant. The record keeper 340 may also maintains a database 346 of land tracts including those participants having rights to each land tract. The database 346 may also contain historical records income produced by each tract and an appraised or estimated value of each tract. These data bases may initially populate from records transferred from the government agencies 370. Each participant's account may be treated similarly to a Totten Trust bank account that allows the participant to designate a beneficiary and thus avoid probate. The record keeper 340 may maintain a database 344 of the beneficiaries designated by at least some of the participants. The record keeper 340 may also have a reporting function 348 to generate and distribute reports, tax forms, and other documents to participants 310 and government agencies 370 as requested by the participants and/or required by law.

The web server 330 and the record keeper 340 may be coupled to a transaction processing agent 320. The transaction processing agent 320 may include an income distribution module 322 to distribute income received from the government agencies 370. The income to be distributed may originate from coal sales, timber harvesting, oil and gas leases, grazing and farming leases, and other rights-of-way and lease activity. Income related to a specific tract or land trust may be distributed to participants having rights to that tract, as documented in the tract database 346. Where possible, income may be distributed to participants 310 via direct deposits to the participants' banks 350.

The transaction processing agent 320 may also include a transfer management module 324 to manage sales, purchases, exchanges, and other transfers of rights between participants. The transfer management module 324 may serve as broker for land trust rights and may provide a listing service or bulletin board on which potential sellers may post rights available for purchase. The transfer management module 324 may also manage transfers of rights between participants and a land trust fund 360. The land trust fund 360 may consolidate land trust rights by acquiring fractional rights from participants. The land trust fund 360 may issue shares to participants, either by sale or by exchange for fractional land trust rights. The transaction processing agent may manage transfers by matching sellers with buyers, collecting funds or other assets from sellers and disbursing funds or other assets to sellers, and by causing the record keeper 340 to update the participant and tract databases 342, 346 to reflect completed transactions.

The functional elements of the system 300 may be implemented by software programs executed by one or more computing device. When two or more computing devices are present, the functional partitioning of the system 300 shown in FIG. 3 need not coincide with a physical partitioning of the system 300 between the multiple computing devices. Multiple functional elements may be implemented within the same computing device, and any functional element may be partitioned between two or more computing devices.

A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

Software programs for implementing the functional elements described herein may be stored on machine readable storage media in a storage device included with or otherwise coupled or attached to a computing device. That is, the software may be stored in electronic, machine readable media. These storage media include, for example, magnetic media such as hard disks, optical media such as compact disks (CD-ROM and CD-RW) and digital versatile disks (DVD and DVD±RW); flash memory cards, and other storage media. As used herein, a storage device is a device that allows for reading and/or writing to a storage medium. Storage devices include hard disk drives, DVD drives, flash memory devices, and others. The term storage media means a physical object for storing information does not encompass transitory media such as propagating signals and waveforms.

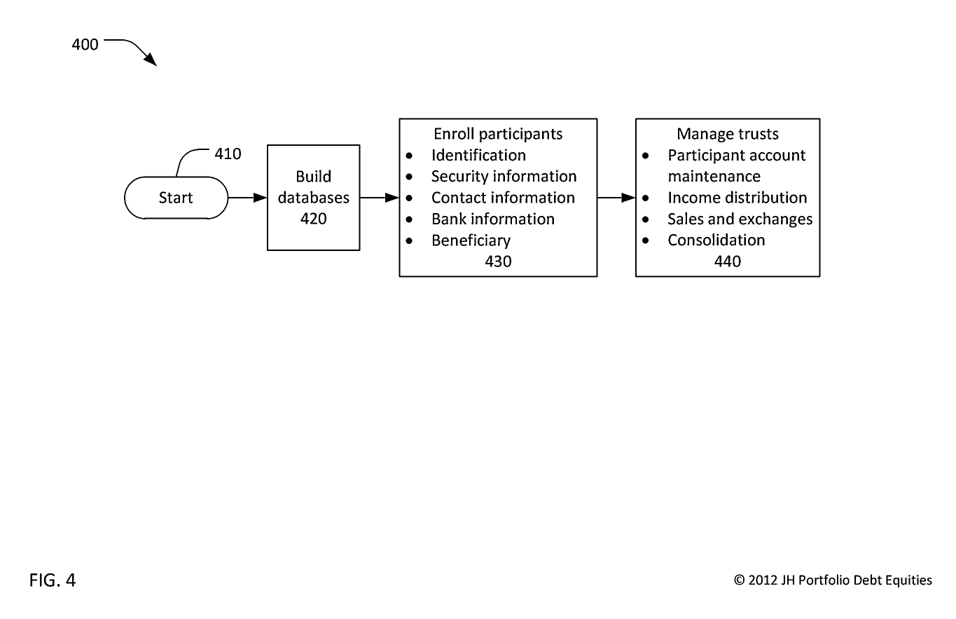

FIG. 4 is a flow chart of a process 400 for managing Native American land trusts using a system such as the system 300. The process 400 starts at 410 when the use of the system 300 is authorized. In the absence of changes to Federal Laws relating to Native American land trusts, the process 400 may continue indefinitely.

As the initial step in the process 400, participant and tract databases, such as the databases 342 and 346, may be built. The databases may be built, to a great extent, by transferring existing digital records of the Bureau of Indian Affairs and other government agencies. In situations where digital information is not available, building the databases at 420 may also include selective digitization of data from paper documents. Building the databases at 420 may further include appraising or otherwise establishing a value for each land tract.

After or while the databases are built at 420, 430 participants may be enrolled for online access to the system 300. Participants may be enrolled using an Internet web site accessed via the participant's personal computer or personal communications device such as a smart phone. Enrolling participants at 430 may be accomplished using purpose-built kiosks installed at convenient locations such as tribal offices. Participants may be enrolled at 430 using other electronic methods, or other non-electronic methods. For example, the program registration may be carried out using a text message system, an automated voice recognition system, or any of a variety of other electronic communications systems.

Enrolling participants at 430 may include establishing the enrollee's identity and defining security information such as a user name and password to allow the enrollee to access the system and to ensure confidentiality of the enrollee's personal information. Enrolling participants may also include acquiring current contact information including a mailing address and, if available, an e-mail address for each participant. During the enrollment process, participants may be encouraged, but not necessarily required, to enter banking information to allow automatic distribution of monies into the participant's bank account and to designate one or more beneficiaries.

After or while participants are enrolled at 430, the Native American land trusts may be managed at 440. Managing the Native American land trusts at 440 may include maintaining participant accounts, including updating participant contact information and beneficiary designations, reporting account status and holdings, and updating account records and databases in the event of a participant's death. Managing the Native American land trusts at 440 may also include distributing income derived from land tracts to participants owning an interest in the tracts.

Managing the Native American land trusts at 440 may also include managing sales, purchases, exchanges, and other transfers of rights between participants. A listing service or bulletin board may be provided for potential sellers to post rights available for purchase. Sellers may be matched with buyers, funds or other assets may be collected from buyers and disbursed to sellers, and participant and tract databases may be updated to reflect completed transactions.

Managing the Native American land trusts at 440 may also include consolidating fractional interests by encouraging participants to dispose of very small interests. Consolidating may be accomplished, at least in part, by facilitating transfers of fractional rights from participants to a land trust fund as previously described. The land trust fund may consolidate land trust rights by acquiring fractional rights from participants either as case purchases or in exchange for shares in the land trust fund. The land trust fund may also issue shares for purchase by participants.

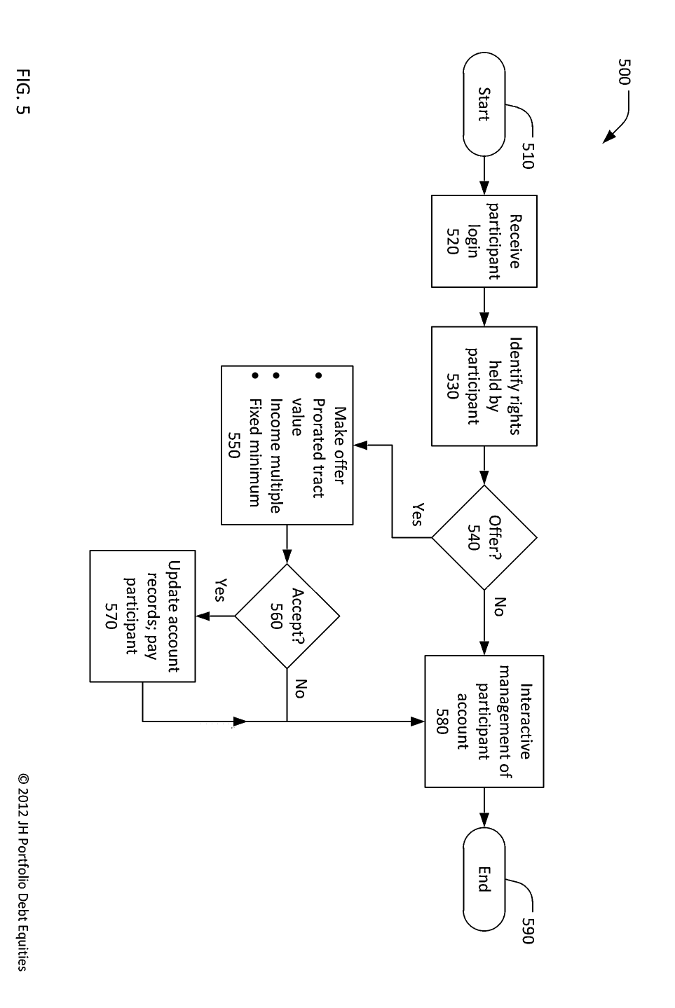

Referring now to FIG. 5, a process 500 for consolidating Native American land trust interests may start at 510 and conclude at 590. The process 500 may be performed by a land trust management system such as the system 300. The process 500 may be performed each time a participant logs into the land trust management system.

At 520, a participant may login to the land trust management system. For example, the participant may enter a user name and password to login to the land trust management system over the Internet. The participant may login to the system using a tribal identification card or other identification card at a kiosk dedicated to accessing the land trust management system. The participant may login to the land trust management system in some other manner.

The rights held by the participant may be identified at 530. The rights held by the participant may be, for example, extracted from a database.

At 540, a determination may be made whether or not to make an offer to buy some or all of the right held by the participant. The determination may be made at 540 automatically based on one or more of the number of different rights held by the participant, the number of rights owners for each land tract, the income produced by each right, and the value of the fractional land tract associated with each right. The determination whether or not to offer to purchase some or all of the rights held by the participant made in accordance with one or more predetermined rules.

For example, as described in the Background of the Invention, in 1987, the annual cost to administer a representative land tract was $40 per rights holder. It is believed that a substantial portion of these costs were incurred mailing paper checks and reports to the rights holders. While a system such as the system 300 may substantially reduce these costs through the use of electronic deposits and on-line reports, the cost to administer a single rights holder may still be substantially greater than the income provided to the rights holder. Thus, to reduce the annual administrative costs associated with land trust management, one of the rules applied at 540 may be to offer to purchase any right where the annual income provided to the participant is less than the annual cost of administering that right. Other examples of rules that may be applied at 540 include offering to purchase any right to less than a predetermined fraction (e.g. 1% or 0.1% or some other fraction) of a tract, or offering to purchase any right to a fraction of a tract that has a value below a first predetermined threshold or that produces an annual income below a second predetermined threshold.

If a determination is made at 540 to make an offer to purchase some or all of the participant's rights, an offer may be made at 550. The offer may propose a purchase price for each right or a combine price for multiple rights. The purchase price may be based, for example, on a prorated tract value (i.e. the value of the tract established at 420 in the process 400 time the ownership fraction) or a multiple of the annual income produced by the right. However, in cases of extremely fragmented ownership, the prorated tract value may be a negligible amount which may not motivate the participant to sell the right. In these cases, the proposed purchase price may be a predetermined minimum bid that is greater than the prorated tract value. For example, an overall reduction in the cost of managing Native American land trust may be reduced if small fractional rights were purchased at a price comparable to the annual cost of administering each fractional right.

If a determination is made at 540 to not make an offer to purchase any rights, the process 500 may proceed to 580 for interactive management of the participant's account as previously described. Similarly, if an offer is made at 550 but not accepted at 560, the process 500 may proceed to 580.

If an offer is made at 550 and accepted at 560, the participant's account records and the records associate with the tracts in question may be updated at 570 to reflect the transfer of rights. The rights purchased at 570 may be assigned to a land trust fund, such as the land trust fund 360, at their prorated value. An excess of the purchase price over the prorated value may be considered a nonrecurring administrative expense. The participant may also be paid at 570. Payment may be made by direct deposit into the participant bank account, by a mailed check, by crediting shares in the land trust fund to the participant's account, or in some other manner.

As shown in FIG. 5, the identification of the rights held by the participant at 530 and the determination at 540 are performed after, and in response to, receiving the participant's login at 520. In a variation of the process 500, the identification of the rights held by the participant at 530 and the determination at 540 may be made without the participant being logged in to the system. In this case, an offer may be conveyed to the participant at 550, for example, by e-mail, and the participant may login to the system at 520 in response to the offer.

Another variation of a process for managing Native American land trusts may automatically make an offer to purchase all of a participant's rights and thus dispense with the action at 540 in the process 500. For example, an annual budget may be established for acquiring fractional rights and rights may be purchased on a first-come, first-served basis until the annual budget is consumed.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A process performed by a automated system for managing Native American land trust rights, comprising:
receiving login information from a participant;
accessing an account record associated with the participant to identify one or more land trust rights held by the participant;
automatically making an offer to purchase at least one land trust right of the one or more land trust rights held by the participant;
receiving an input from the participant accepting or rejecting the offer to purchase; and
upon acceptance of the offer, disbursing payment to the participant in accordance with the offer to purchase and updating the account record associated with the participant to reflect a sale of the at least one land trust right.

2. The process of claim 1, wherein
accessing the account record and automatically making the offer to purchase occur in response to the receiving the login information from the participant.

3. The process of claim 1, wherein
accessing the account record and automatically making the offer to purchase occur prior to receiving the login information from the participant.

4. The process of claim 3, wherein
the participant provides the login information in response to receiving the offer to purchase.

5. The process of claim 3, wherein
making the offer to purchase comprises sending the offer to purchase to the participant via e-mail.

6. The process of claim 1, further comprising:
after indentifying the one or more lands trust rights held by the participant, determining whether or not to make the offer to purchase at least one land trust right.

7. The process of claim 6, wherein
determining whether or not to make the offer to purchase the at least one land trust right is based on one or more of a number of different rights held by the participant, a number of owners of rights in the at least one land trust right, income produced by a fractional land tracts respectively associated with the at least one land tract right, and a value of fractional land tracts respectively associated with the at least one land tract right.

8. The process of claim 1, wherein
the offer to purchase includes an offer price, the offer price being a larger one of a prorated value of one or more land tracts respectively associated with the one or more land trust right and a predetermined minimum offer price.

9. An automated system for managing Native American land trust rights, comprising:
a web server running a client portal application, the web server configured to receive participant login information;
a record keeper coupled to the web server, the record keeper storing records associated with a plurality of participants; and
a transaction processing agent coupled to the web server and the record keeper, the transaction processing agent configured to:
access an account record associated with the participant held by the record keeper to identify one or more land trust rights held by the participant,
make an offer to purchase at least one land trust right of the one or more land trust rights held by the participant, and
upon receipt by the web server of an input from the participant accepting the offer to purchase, disburse payment to the participant in accordance with the offer to purchase and cause the record keeper to update the account record associated with the participant to reflect a sale of the at least one land trust right.

10. The automated system of claim 9, wherein the transaction processing agent is configured to access the account record and automatically make the offer to purchase in response to the web server receiving the login information from the participant.

11. The automated system of claim 9, wherein the transaction processing agent is configured to access the account record and automatically make the offer to purchase prior to the web server receiving the login information from the participant.

12. The automated system of claim 11, wherein
the participant provides the login information to the web server in response to receiving the offer to purchase.

13. The automated system of claim 11, wherein the transaction processing agent is configured to send the offer to purchase to the participant via e-mail.

14. The automated system of claim 13, wherein the transaction processing agent is configured to determine whether or not to make the offer to purchase the at least one land trust right after identifying the one or more land trust rights held by the participant.

15. The automated system of claim 14, wherein the transaction processing agent is configured to determine whether or not to make the offer to purchase the at least one land trust right based on one or more of a number of different rights held by the participant, a number of owners of rights in the at least one land trust right, income produced by a fractional land tracts respectively associated with the at least one land tract right, and a value of fractional land tracts respectively associated with the at least one land tract right.

16. The automated system of claim 9, wherein
the offer to purchase includes an offer price, the offer price being a larger one of a prorated value of one or more land tracts respectively associated with the one or more land trust right and a predetermined minimum offer price.
